(19) United States
(12) Patent Application Publication
(10) Pub. No.: US 2020/0090142 A1
(43) Pub. Date: Mar. 19, 2020

(54) FINANCIAL TRANSACTIONS SYSTEM AND METHOD UTILIZING BLOCKCHAIN TRANSFERS

(71) Applicant: Roberto Enrique Kafati, Miami, FL (US)

(72) Inventor: Roberto Enrique Kafati, Miami, FL (US)

(21) Appl. No.: 16/551,376

(22) Filed: Aug. 26, 2019

Related U.S. Application Data
(60) Provisional application No. 62/722,645, filed on Aug. 24, 2018.

(51) Int. Cl. G06Q 20/06; G06Q 20/36; G06Q 20/40; G06Q 20/38

(52) U.S. Cl. CPC G06Q 20/0652; G06Q 20/3678; G06Q 20/3676; G06Q 2220/00; G06Q 20/40; G06Q 20/381; G06Q 20/389; G06Q 20/3672

(57) ABSTRACT

A system and method for achieving financial transactions utilizing blockchain transfers wherein a microprocessor is coupled to at least one network adapter and is operable to access memory and execute computer-readable instructions to receive a transfer of a cryptocurrency amount into a first account; define a value to that cryptocurrency at that time and peg that value to the cryptocurrency until a subsequent financial transaction wherein at least a portion of the cryptocurrency is used to satisfy a transaction amount based upon a pegged value rather than a then current value. A hedging mechanism can be implemented to mitigate volatility of the incoming currency, such as a cryptocurrency.

### CLAIM OF PRIORITY

The present Non-Provisional patent application claims priority pursuant to 35 U.S.C. Section 119(e) to a currently pending and prior filed Provisional patent application, namely, that having Ser. No. 62/722,645 filed on Aug. 24, 2018, the content of which is incorporated herein by reference in its entirety.

### FIELD OF THE DISCLOSURE

The present disclosure is generally directed to systems and methods for achieving financial transactions utilizing blockchain transfers.

### BACKGROUND

Currently, cryptocurrency transactions suffer from a wide range of difficulties. Some of these difficulties include liquidity constraints, substantial volatility, lack of demand, lack of acceptance for a transaction to occur, and unclear regulations which have inhibited the use of cryptocurrencies in cross-border payments. These difficulties also hinder a broader adoption of cryptocurrencies as a tool for cross-border transactions. While some transaction solutions have focused on increasing transaction speeds in order to make cash-in and cash-out solutions more feasible, these attempts have largely failed because of scalability issues stemming from liquidity constraints in the recipient market, among other factors, such as the requirement that operators be money service businesses (MSBs).

Cash-in and cash-out solutions are those that rely on the purchase of a cryptocurrency or blockchain asset from a local exchange and then send a transaction from one location to another. Upon arrival, the transaction is immediately exchanged for the nominal value according to local currency exchange rates. Nonetheless, cash-in and cash-out solutions eventually suffer from liquidity constraints in the receiving locations because transactions consist mostly of one-way transaction flows. In the receiving country, there is insufficient or non-existing demand to exchange local currency for cryptocurrency or blockchain assets given the relatively one-sided directionality of transactions. This results in a liquidity constraint that ultimately devalues incoming transactions given the rising transaction costs associated with the ability to obtain local currency from cryptocurrencies or blockchain assets.

There is a need for a system that can solve, manage, or otherwise mitigate the obstacles currently associated with primarily one-way, but also possibly bi-directional, transactions of cross-border transactions and exchanges, such as remittances, including, but not limited to, lack of demand or acceptance of cryptocurrency and/or the volatility that is typically associated with many blockchain/cryptocurrency transactions.

### SUMMARY OF THE INVENTION

The present invention relates to a financial transaction system and method that utilizes block chain transfers to effectuate convenient and efficient financial transfers to facilitate the completion of financial transactions, including preferably transactions that typically are not quantifiable based upon cryptocurrency values. In this regard, the present method involves the creation of a user account. Typically this user account is held and/or maintained by the recipient of a financial transfer or remittance who may wish to conduct a financial transaction. This user account, which can be maintained on one or more microprocessors such as a central cryptocurrency exchange and/or account servers or on an independent cryptocurrency storage device, such as a cryptocurrency wallet, is monitored, such as via a network adaptor, by a central server and/or account management system. This monitoring can take place at all times, or simply when transactions into and/or out of said first account are achieved.

Next, an amount of cryptocurrency is transferred into said user account. As described in more detail subsequently, this transfer can be direct user to user transfer and/or transfer via an exchange and/or via the central server, preferably in amount customary for the secure transfer of cryptocurrency. At generally the time and/or with some correlation to the time when the cryptocurrency is transferred to the first or user account, the cryptocurrency is assigned a second value by the present system and method. Of note, this second value preferably corresponds to a value classification that is different than the value classification of the cryptocurrency. By way example, the value classifications can be considered different currencies, wherein the value classification of the cryptocurrency can be BITCOIN® and the value classification of the second value can be U.S. dollars. Furthermore, the second value is assigned based upon a then current value of said second value's value classification, preferably as compared to the then current value of the cryptocurrency. By way of example an exchange rate between the cryptocurrency and USD on or about or related to the time of the transfer can be set and pegged to that cryptocurrency. Further, because the cryptocurrency is defined in terms of blocks of a blockchain, the second value can, if desired, be linked or pegged to that specific cryptocurrency transferred. Moreover, if desired, a transaction fee can be deducted or removed from that second vale determination assigned to that cryptocurrency.

With the properly valued cryptocurrency in the second value, a user is able to conduct a financial transaction for a specific transaction value with someone else that preferably has a second account. Notably, the value classification of the transaction value can be the same as the value classification of the second value, wherein there is a predefined one to one exchange, or it can be different, with a different predefined exchange, such as from one national fiat currency to another.

Preferably the system and method of the present invention is configured such that the financial transaction cannot take place using value in the user account without approval by a central server and/or central account so as to ensure that proper valuation of the cryptocurrency as will be described is maintained. Optimally, this can be achieved by only permitting transactions with affiliated or approved holders of second accounts, such as defined merchants or ATM machines.

When the financial transaction is initiated with the second account, a transaction amount of cryptocurrency required to satisfy the transaction value is determined or defined. This transaction amount of cryptocurrency is determined as a proportion of the second value for the cryptocurrency being used compared to the transaction value. For example, an exchange rate between the value classification of the second value and the transaction value are determined and the corresponding amount of cryptocurrency needed to achieve the amount of second vale needed to satisfy the exchange is defined as the transaction amount. Notably, this is defined independent of the then value of the second value classification at the time of the financial transaction. For example, if a transaction involves an initial valuation of an amount of cryptocurrency at USD$1000, wherein USD is the value classification for the second value, in connection with the initial transfer into the user account, but at the time when the financial transaction is to take place the value of cryptocurrency to USD has gone up since the initial transfer and valuation is made, the new higher exchange that may have assigned a second value to that same cryptocurrency at USD$2000 at that new exchange is not used, but rather the original valuation that was defined and pegged to that cryptocurrency is used to define the transaction amount. The same would be the case if the value has gone down, as the system and method of the present guarantees the second value independent of fluctuations.

In this regard, the system and method may also include a hedging mechanism. The hedging mechanism is structured to identify the then current value of the second value classification at a time of initial transfer into a user account, and in some cases sell a certain amount of cryptocurrency from a liquidity account to correspond all or part of the second value. Therefore, that second value, which at some point in the future may be needed to satisfy that financial transaction is maintained insulated from fluctuations in the value of the value classifications relative to one another. Preferably, however, an equal amount to satisfy the second value is not needed to be liquidated and/or the liquidation of all or part of cryptocurrency that was acquired at a reduced valuation can be liquidated.

Once the transaction amount is defined, the corresponding transaction amount of the cryptocurrency is allocated to the satisfy the transaction value. Although in some cases the second account can be structured to receive the transaction amount of cryptocurrency as the allocation, in other embodiments the transaction value can be transferred only temporarily for ultimate transfer to a central account, and/or the second account can be configured connected to the central account such that a direct or pass through transfer of the transaction amount to the central account can be achieved. As yet another variation, the pre-transfer or subsequent transfer to the central account can be achieved as the allocation, such as by placing limits on the user account to transfer the allocated cryptocurrency until a connection can be achieved with the central account, or by receiving the transfer to the central account in advance and providing credit or value allocation corresponding to the transaction value for later use by the user.

Finally, in a preferred embodiment, the transaction value is transferred to the second account to satisfy the requirements of the financial transaction. This can be achieved when the cryptocurrency is sold from the second account independently or is transferred to the central account, or preferably, if the transaction amount of cryptocurrency is sent to the central account, by a transfer from or related to the central account of the transaction value in the transaction value classification. For example, the cryptocurrency is transferred to the central server, and a fiat currency transaction is sent to the second account.

Notably, if more cryptocurrency is added to the first or user account at a later time, a new second value associated with the then corresponding exchange or comparison between the second value's value classification and the cryptocurrency's value classification can be achieved. In this regard, the system of the present invention can be structured to select which cryptocurrency at which valuation will be used to satisfy a financial transaction. For example, it can be structured to sell the oldest holdings, or, such as in conjunction with the hedging mechanism or otherwise, can select cryptocurrency to allocate so as to maximize returns, such as by holding onto higher cost basis cryptocurrency and liquidating lower cost basis cryptocurrency.

Referring again to the background, some or all of the above needs and/or problems may be addressed by certain embodiments of the disclosure. As explained in more detail below, the proposed systems and methods can overcome the issues of volatility and liquidity constraints, among other obstacles. For example, certain embodiments of the systems and methods can guarantee the value of a transaction at the time it is received by an affiliated wallet. The percent value of the assets or funds resulting from the hedging of a transaction can count toward the total nominal funds that consist of the purchasing power of an individual within the system. The system is configured to allow an individual to purchase at affiliated partner businesses, transact with other affiliated wallets, and even transact with other unaffiliated wallets through transactions in system-compatible cryptocurrencies or blockchain assets, preferably as long as the value of the outgoing transaction is less than the total nominal value. The system disclosed herein uses a hedging mechanism that locks a price of an incoming transaction through agreements and can therefore overcome volatility. In certain situations, the system can overcome liquidity constraints by minimizing the amount of local currency needed and by working with a currency with liquid markets, such as the U.S. dollar (“USD”).

The solutions proposed herein can sufficiently mitigate at least some of the obstacles, most importantly those concerned with liquidity, acceptance of value, and volatility. The present disclosure is also concerned with the ability to guarantee the value of a transaction especially, but not limited to, peer-to-peer transactions, and it can do so, for example, by restricting the potential outputs of a received transaction and/or by guaranteeing the equivalent to the value of the transaction at the time the transaction occurred, minus any applicable fees. This solution can allow transactions in any cryptocurrency or blockchain asset to be carried out and to transact the value without the risk of the volatility that prevails in the exchanges in which these assets are currently traded.

As described in more detail below, and illustrated in the accompanying figures, embodiments of the invention can contain a hedging mechanism to sell the amount of cryptocurrency or blockchain assets at the time received by an affiliated wallet. An affiliated, or system, wallet is a wallet that can receive a transaction from any other wallet, but can be restricted to spending a given cryptocurrency or blockchain asset according to restrictions imposed by the system and abiding by system protocols. System restrictions can ensure that the amount of a given cryptocurrency or blockchain asset, which was sold at the time of an incoming transaction to guarantee the nominal value, can stay within the system and can eventually be recovered and traded for the specific nominal value at the time of the transaction, minus any applicable fees. Optimally the hedging component secures that value.

The hedging mechanism can be applied to paper wallets, or any other type of physical wallet, and not solely intended for digital wallets. This flexible wallet approach can be achieved, at least in part, because the hedging mechanism can rely on computer servers to scan incoming transactions to an affiliated wallet, in addition to affiliated wallets reporting incoming transactions, among other potential event-listening, tracking, and triggering techniques. In certain embodiments disclosed herein, affiliated wallets can utilize the nominal value at the time of each incoming transaction, and/or the sum of these nominal values, to purchase goods and/or services from partner businesses, and/or to transfer nominal value to other affiliated wallets. The value of already hedged transactions (those transactions whose value at first arrival at an affiliated wallet or private key has been guaranteed) can be sent from affiliated wallets to unaffiliated wallets for an amount equivalent to the nominal value of the initial hedged transaction, minus any applicable fees. Therefore, an individual with a system-compatible wallet can receive $100 worth of cryptocurrency or blockchain asset, and can resend the $100 value minus applicable fees regardless of price fluctuations, through the system and/or by abiding by the system's protocols.

Accordingly and as indicated, the system and method for exchanging cryptocurrency of the present invention can be implemented utilizing at least one microprocessor, at least one network adapter and at least one memory storing computer-executable instructions, wherein the microprocessor is coupled to the network adapter and is operable to access the at least one memory and execute the computer-readable instructions to receive a transfer of a cryptocurrency amount into at least a first account; exchange at least a portion of said cryptocurrency amount for a second currency; and transfer said second currency into at least a second account.

These and other objects, features, and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a flow diagram of an example method for cryptocurrency exchange.

FIG. 2 illustrates an example system for exchanging cryptocurrency.

Like reference numerals refer to like parts throughout the several views of the drawings.

### DETAILED DESCRIPTION

Illustrative embodiments of the disclosure will now be described more fully hereinafter with reference to the accompanying drawings in which some, but not all, embodiments of the disclosure are shown. The disclosure may be embodied in many different forms and should not be construed as limited to the embodiments set forth herein; rather, these embodiments are provided so this disclosure will satisfy applicable legal requirements.

Certain embodiments disclosed herein relate to what can be referred to as a cryptocurrency exchange. For purposes of clarity, cryptocurrency is generally used to reference a tradeable asset or currency built on blockchain technology. It is understood, however, that in the context of the present invention, the term cryptocurrency can include any type of digital tradeable asset even if not built on blockchain per se. Accordingly, a method can be provided to receive an amount of cryptocurrency into a user's account. The method can associate or peg the amount of cryptocurrency with a value of a different currency or asset. The method can then pay part or all of the cryptocurrency value into a different currency or asset, preferably at the pegged value. The method can also include making said paid value available to the user via retail means.

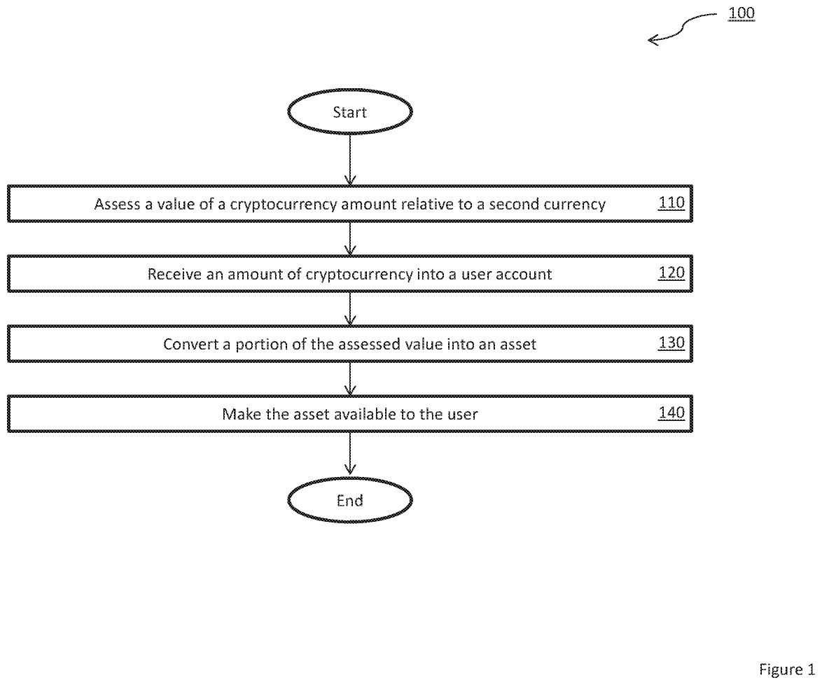

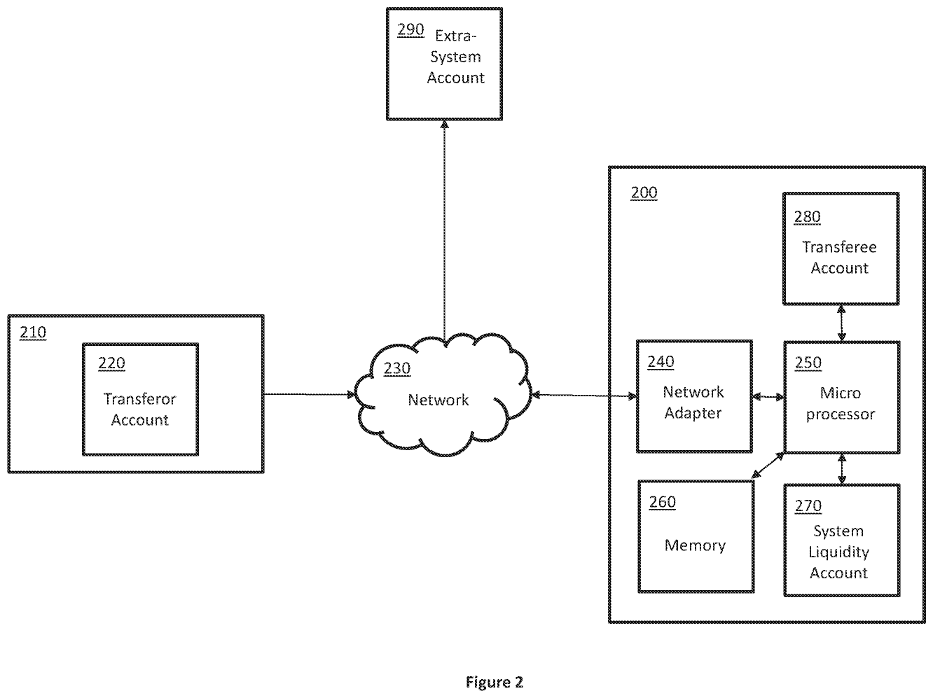

FIG. 1 depicts a flow diagram of an example method 100 for exchanging cryptocurrency, according to an illustrative embodiment of the disclosure. The method may be utilized in association with various systems, such as system 200 illustrated in FIG. 2.

The method 100 may begin at block 110. At block 110, method 100 can assess a nominal value of the amount of cryptocurrency to be received, being received, or already received in a user account. In some embodiments, method 100 can be directly implemented regarding a proposed or occurring transaction for at least one account under its control. In some embodiments, method 100 can monitor a network or blockchain of currency transactions, including cryptocurrency transactions. Method 100 can then review the identification of the accounts involved in the transaction to determine if at least one of the accounts is governed by a system that uses method 100. Method 100 can reject a proposed transaction according to a preprogrammed algorithm based on, for example, which if any of the accounts to be used in the proposed transaction are affiliated with a system that uses method 100. These affiliated accounts can be referred to herein as “member wallets.” In one embodiment, method 100 can reject or not process a proposed or occurring transaction that originates from a member wallet and is destined for a non-member wallet, such as in order to maintain the pegged nominal value that was established at the initiation of the transaction. In some embodiments, method 100 can use a public market system to assess a value of the incoming cryptocurrency amount. Preferably, the method 100 can use an assessment provided by a centralized system for the value to which the cryptocurrency amount is to be converted. For example, method 100 can use an assessed value in USD as a basis for the cryptocurrency exchange, using that value as the pegged or set amount for the specific cryptocurrency being acquired or designated for use in the present system and method. If more than one assessment value is provided for a given conversion currency, method 100 can determine, via an assessment algorithm, which value or values to use to determine the exchange amount, and which formula(s) to use to effect that determination. The assessment can be done using any fiat currency and/or distributed ledger technology (DLT) asset, for example the monetary unit of any nation. In some embodiments, method 100 can assess or peg a value to the cryptocurrency based on an equivalent value in store credit and/or other benefit such as lower fees. The store-based value can be determined on a per-store basis or it can be a determination for any type of store credit. In some embodiments, method 100 can use a second cryptocurrency, different from the first, to assess a value for the amount to be converted. Then the equivalent amount of the second cryptocurrency or a portion thereof, as determined by method 100, can be used in a further transaction by the recipient user. Method 100 is able to exchange any cryptocurrency, for example BITCOIN®, ETHEREUM®, LITECOIN®, or any other cryptocurrency, now existing or future traded.

Next, at block 120, an amount of cryptocurrency can be received into a user account, or wallet. The value of such a transaction would be assigned to such a user account or wallet at a system identified value if coming from a system wallet or by a hedging component at the time of the transaction if coming from a non-system wallet or account. The hedging component is configured to set or peg the value of the transferred cryptocurrency to a desired amount in an intended use currency or credit. The transaction can be received by any network adapter and over any computer network capable of carrying such a transaction. The transaction can include the use of many networks and network adapters, depending on the communication logistics required for the particular transaction. For example, the network can include cellular communication, wide area networks such as the internet, Bluetooth or Wi-Fi technology, RFID or any other communication protocols and devices used for network transactions. The user account can be set up in advance and can be implemented through a wallet, such as a hardware, software, or paper wallet, as those terms are used with digital currency. The incoming asset can include any valid cryptocurrency, for example those named above. The incoming asset can also include any other currency, such as fiat currencies. The source of the currency to be received can be from another account or wallet that is set up within the system used by method 100, or the source can be from a wallet outside the system.

Prior to receiving the transaction, method 100 can also include receiving a request for the transaction. In some embodiments, such a request, such as between system wallets, may be necessary for a transaction. The request can include the amount of currency for the proposed transaction, the type of currency, sender information, and other details pertinent to complete a transaction. The request can also include a retailer code to identify the store, ATM, or other entity to be involved in the transaction. Method 100 can weigh this information via an algorithm running on at least one microprocessor, to determine whether to accept the request for the transaction and/or to determine or peg a value. In one embodiment, the algorithm can choose to not accept, disregard, process or decrypt the request based on an evaluation of the information. For example, if the proposed transaction amount is higher than the algorithm is programmed to accept, then method 100 can reject the request. Additionally, method 100 may be unable to decrypt the requested information correctly or the request may lack required elements, such as multi signature approval, causing an inability to process the request. In one embodiment, method 100 can include reserving an amount of currency, for example USD, for incoming transactions, and an algorithm can set the incoming transaction limit based on the amount of reserves remaining. In some embodiments, method 100 can communicate information to a sender, such as a maximum allowed amount if the amount is too great. In another example, if the algorithm determines that the information provided in the request is fit for a transaction in the system, then method 100 can accept the request and proceed with the transaction. By way of example, if the system is able to decrypt the transaction, it may not require multiple signatures. In this fashion, the system is able to set the parameters required to achieve an acceptable transaction.

Next, at block 130, method 100 allows a user to exchange or utilize at least a portion of the accepted transaction amount into another asset based upon the pegged value. As described elsewhere herein, the asset to be converted to can include fiat currency, cryptocurrency, and credit. Such an asset conversion could result or be in addition to a debit fiat value to which the hedging mechanism pegs or sets the value of the accepted or incoming transaction amount at the present value/time the transaction was received. The conversion can also include multiple assets and multiple types of assets. In some embodiments, the single receiving of a currency, for example a cryptocurrency, can be converted into multiple other assets. In some embodiments, an incoming cryptocurrency amount can be exchanged by method 100 purchasing the incoming cryptocurrency amount from the recipient of the transaction in the currency that the recipient desires. For example, a recipient in Honduras of a cryptocurrency transfer may desire an exchange of the cryptocurrency into a fiat currency such as USD or lempiras. Method 100 can deposit into the recipient's account the fiat currency value, and can accept into a system account the cryptocurrency amount. Method 100 can promote liquidity in these often unidirectional transactions because method 100 can have broad access to markets in general, and cryptocurrency markets in particular. In one embodiment, a system account of fiat currency can be managed, by a computer running an investment algorithm for example, to ensure the amount of cryptocurrency coming in is efficiently converted back into fiat currency, or other asset. The algorithm can include securing a market for incoming cryptocurrency, in advance if necessary. In one embodiment, the algorithm can establish a list of cryptocurrency investment entities that prepay, in fiat currency for example, for a future cryptocurrency transaction. With this store of liquidity, method 100 can provide more unidirectional cryptocurrency transactions. In some embodiments, the store of liquidity can include other assets, for example, precious metals, precious stones, oil reserves, and business credit, to name just a few. The system can, by way of example, also use the hedging mechanism or other connected components to exchange the applicable amount of oil reserves, business credit, or other asset for the incoming amount of cryptocurrency. In some embodiments, the system storage of assets can include accounts held by individual investors, and the provided and/or promised assets of a single investor can be used to satisfy a transaction. In other embodiments, a single transaction can be distributed across account assets provided by multiple investors, and the percentage distribution can be determined by the algorithm.

In some embodiments, converting the incoming currency into a different currency can include deducting a fee. The fee can include transaction costs for converting between the incoming and outgoing currencies, and the fee can include regulatory, maintenance, and licensing costs. In some embodiments, the fee can include a usage fee for implementation and execution of method 100. The fee can be calculated by a fee algorithm, and the fee can be deducted from the incoming value as determined by the fee algorithm or on a predefined basis including one or more factors such as the amount, source of origin, destination, etc. For example, the fee algorithm can direct method 100 to withdraw the fee amount from at least one of the investor or user accounts based in part on which accounts will be used to satisfy the transaction. In some embodiments, method 100 can deduct a portion of the total fee from several investor accounts, based at least in part on the amount of contribution to the transaction from each investor account. In some embodiments, method 100 can deduct the fee from the incoming cryptocurrency, or other asset, prior to exchange with the second currency account. In some embodiments, the amount of the fee can be communicated to the depositing party and to the receiving party prior to acceptance of the transaction. The communication can be via a computer screen display on a device used by one or both the parties, and the communication can be conveyed via an audible or text-based message, such as via email or short message service (SMS) and/or internal system communication and/or RFID. The amount of the fees can be based on the nominal value of the currency, good, or service involved in the transaction, as well as the type and method of transaction, the user account 280 involved, and other factors. Method 100 can then receive a request from one or both of the parties to reject the proposed transaction, based at least in part on the fee amount.

Next, at block 140, method 100 can allow the total amount or a portion of the total amount of the transaction to be converted for immediate use. For example, a recipient user can withdraw the transaction amount, now deposited in the user's account, from a local automated teller machine (ATM) affiliated with the current system and method in the local currency. In whichever nation the user may be located at that time, method 100 can convert the incoming amount into local currency and/or redemption credits with an affiliate partner, as described in more detail herein. In some embodiments, an ATM can be located in an establishment that is operated by a user of the system implemented by method 100. In some embodiments, method 100 can convert portions of the transmitted amount into multiple currencies, and the user account can represent the multiple currencies. In one embodiment, the converted amount can be accessible to the recipient via retail store credit. For example, a retail store can provide the value, or a portion of the value, of the incoming transaction in store credit and goods/services as determined by the system. In some embodiments, the participating retail store can be an investor of the liquidity mechanism of method 100 or have the means to utilize components of the method 100. In some embodiments, the value or a portion of the value can be converted into other types of credit, for example business or corporate credit. In this example, the desired portion of the transaction amount can be used toward a business credit or debt. In one embodiment, either through a retailer wallet affiliated with the method, but self-managed, or a wallet managed by the system's affiliated entities, a portion of the value can be used to pay one or more bills, such as utility bills or credit card bills. In embodiments involving a business or store, method 100 can permit the business or store to retain all or a portion of the incoming cryptocurrency amount with or without pegging its value to another asset. In some embodiments, method 100 can then liquidate some percentage of that held portion at a later date, based on a predetermined amount of time, a predetermined value level of the asset, or upon request by the business.

In one embodiment, a verification algorithm of method 100 can include determining whether to accept a proposed transaction by verifying the public and private keys of the parties involved. In some embodiments, method 100 can use a decryption key, sometimes a proprietary decryption key, to verify and decrypt the parties' keys and possibly other information and/or values related to the transaction. The verification algorithm can use factors such as the user's public key, the proposed decryption key, a private key, and/or the proposed cryptocurrency value, among other factors, to determine whether or not method 100 should accept the proposed transaction. If the request is accepted, method 100 can update the balance of the accounts affected by the transaction, and then, if desired, communicate the transaction to the network and/or to the blockchain. Once a transaction is recorded on the blockchain, or in advance of such recordal, it can be further verified and accepted by other users of the blockchain and of method 100.

The method 100 may optionally end following block 140.

The operations described and shown in the method 100 of FIG. 1 may be carried out or performed in any suitable order as desired in various embodiments of the disclosure, and the method 100 may repeat any number of times. Additionally, in certain embodiments, at least a portion of the operations may be carried out in parallel. Furthermore, in certain embodiments, fewer or more operations as described in FIG. 1 may be performed.

Referring now to FIG. 2, shown is an example system 200 that facilitates cryptocurrency exchange. According to one embodiment of the disclosure, depicted is a system 200. System 200 can include a network adapter 240 to allow for communication within system 200, and between system 200 and outside computers. System 200 can communicate with outside computers via network adapter 240 and network 230. Network adapter 240 can be any hardware or software, or both, adapter capable of establishing and/or carrying on communication between and among computers. System 200 can include multiple hardware and software components that make up a network adapter entity 240 to communicate via network 230. In addition to the different members and components of system 200 communicating among and between each other, system 200 is also capable of communication with entities outside the system 200. In one embodiment, system 200 can communicate with an outside computing device 210 via network adapter 240 and network 230. Computing device 210 can include a bank account or cryptocurrency wallet 220 that holds currency, such as a cryptocurrency.

System 200 supports transactions involving member financial/asset accounts, such as account 280, similar to other financial institutions. In addition to routine financial transactions, system 200 can also support the exchange of cryptocurrencies both within the system 200, and between system accounts and outside accounts. When a non-system financial/asset account 220 wishes to transfer an amount of cryptocurrency to a system account 280, then computing device 210 can request the transfer. System 200 can consider the proposed transfer by evaluating information accessible to it. For example, microprocessor 250 can execute an evaluation algorithm stored in memory 260 to determine if the request should be granted. The evaluation algorithm can weigh the factors it has access to, for example, the assessed value of the proposed cryptocurrency transaction, the current status (including balance) of the system liquidity account 270, the transferee account 280, the proffered public and private keys or decryption keys, and other necessary and discretionary information available to the algorithm. In some embodiments, an algorithm executed by processor 250 can compare the value of the proposed cryptocurrency transfer with an available balance value of the system liquidity account 270 and reject the transfer if the algorithm determines the liquidity account 270 is not sufficiently funded to accept the transaction. If microprocessor 250, executing the algorithm, determines the request for transfer should be accepted, then system 200 can process the transaction.

System 200 can include a hedging mechanism to mitigate the volatility of the incoming currency, such as a cryptocurrency. The hedging can be achieved by such methods as selling from a system liquidity account 270, from centralized or decentralized custodial services (which can include an interest return), and from selling future contracts, among other scenarios. Using the hedging mechanism, the algorithm executed by microprocessor 250 can assess a nominal exchange value to be associated with the incoming amount to the user or transferee account 280. In addition to assessing nominal exchange values prior to a transfer of currency from a transferor account 220 and/or in advance in anticipation of or at the time of transactions, system 200 can also determine a current nominal exchange value prior to transactions originating from a transferee account 280. For example, upon a request for a transaction amount from user account 280 to an account outside system 200, such as account 290, system 200 can determine a nominal exchange value for all currencies of which user account 280 holds value. This is one approach system 200 can use to prevent any overdraft of account 280 that could be caused by the transaction amount beyond the nominal exchange value. Based at least in part on that assessed nominal exchange value, system 200 will not allow any debits or withdrawals from account 280 that would overdraft beyond the balance of account 280. If the algorithm determines the transaction to extra-system account 290 can proceed, then the user can complete that transaction. For transactions that take place between multiple user accounts 280, and do not involve any extra-system account 290, the algorithm can forego an assessment of the nominal exchange value. System 200 can determine which accounts, or wallets, involved in a transaction are member wallets by identifying the unique address of each account. System 200 can then check its database of member wallets to determine if either, or both, of the proposed transaction wallets are member wallets.

In some embodiments, system 200 can create pre-approved transactions in order to make the process faster. System 200 can pre-assess currency values, pre-approve system wallets, and pre-approve extra-system accounts. In one embodiment, system 200 can pre-approve an extra-system account 290 by associating that account 290 with a local or trusted partner.

To accurately identify accounts and transactions, system 200 can include the use of decryption keys, public keys and/or private keys.

Upon receiving the transferred cryptocurrency, system 200 can deposit into transferee account 280 an equivalent value of the assessed cryptocurrency amount, and in a different currency, or can simply maintain the cryptocurrency in the transferee account 280 at a pegged amount, prefereably with some restriction utilizing the hedging mechanism, until they elect to use or transfer it. For example, transferor account 220 can remit an amount of BITCOIN® to transferee account 280 to be used as USD. In this exemplary transaction, system 200 can receive the BITCOIN® amount, and deposit into transferee account 280 the equivalent value in USD. As part of the above noted hedging mechanism the system 200 can then hold onto the cryptocurrency amount or immediately attempt to resell it into the financial markets. System 200 can also both hold onto a portion of the amount and sell a portion of the amount, based on an assessment of the cryptocurrency value as determined, for example, by the assessment algorithm.

The system 200 user who owns transferee account 280, unless they elect to maintain the value in cryptocurrency to take advantage of the hedging mechanism, can then manage the value in that account 280 as if it were any other financial/asset account, for example, by withdrawing USD cash from an ATM 290, or any other alienation of the value. System 200 can also provide access to the user to exchange the transferred amount for credit 290, such as at a retail store or utility company, via network 230 and network adapter 240. With currency now in the transferee account 280, the user can access the transferred value, via an extra-system account, to use as any fiat currency can be used.

In some embodiments, the cryptocurrency can be converted or pegged into denominations of separate currencies, for example different fiat currencies such as USD and lempiras, all of which can be stored within transferee account 280, and possibly restricted in term of use. System 200 can accept cross border transfers of cryptocurrency and convert the value into a local currency for local usage. For example, a transferor account 220 located in the U.S. can transfer a cryptocurrency amount to transferee account 280 located in Honduras. In some embodiments, system 200 can be located in Honduras and can receive the cryptocurrency amount. System 200 can draw lempiras from a liquidity account 270 and deposit the lempiras into transferee account 280 immediately or at the time of the requested financial transaction in order to complete the transfer. The lempiras in transferee account 280 can then be accessible via a Honduran ATM 290, or any other means 290 of accessing the lempiras. In this case, in one embodiment a separate transferee account 280 to receive the lempiras is maintained with the main user account holding the cryptocurrency until the deposit of the lempiras is initiated.

As desired, embodiments of the disclosure may include a system 200 with more or fewer components than are illustrated in FIG. 2. Additionally, certain components of the system 200 may be combined in various embodiments of the disclosure. The system of FIG. 2 is provided by way of example only. While the disclosure has been described in connection with what is presently considered to be the most practical and various embodiments, it is to be understood that the disclosure is not to be limited to the disclosed embodiments but, on the contrary, is intended to cover various modifications and equivalent arrangements included within the spirit and scope of the appended claims.

This written description uses examples to disclose the inventions, including the best mode, and also to enable any person skilled in the art to practice the disclosure, including making and using any devices or systems and performing any incorporated methods. The patentable scope of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium have a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that executed on the computer or other programmable apparatus provide elements or steps for implementing the functions specified in the flow diagram block or blocks.

Accordingly, blocks of the block diagram and flow diagram support combinations of means for performing the specified functions and program instructions means for performing the specified functions. It will also be understood that each block of the block diagram and flow diagram, and combinations of blocks in the block diagram and flow diagram, can be implemented by special purpose, hardware-based computer systems that perform the specified functions, elements or steps, or combinations of special purpose hardware and computer instructions.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A financial transaction method utilizing blockchain transfers, said method comprising:
creating a user account;
monitoring transactions with said user account via at least one network adaptor;
transferring an amount of cryptocurrency into said user account;
identifying said amount of cryptocurrency transferred to said user account via said at least one network adapter, and assigning a second value, corresponding to current value of a second value classification different from said cryptocurrency's value classification, to said amount of cryptocurrency;
initiating a financial transaction of a transaction value with a second account;
defining a transaction amount of said cryptocurrency required to satisfy said transaction value as a proportion of said second value assigned to said amount of cryptocurrency compared to said transaction value, independent of a current value of said cryptocurrency in said second value classification;
allocating, via said at least one network adaptor, said transaction amount of said cryptocurrency to satisfy said amount of said transaction value; and
transferring, via said at least one network adapter, to said second account said transaction value.

2. The method as recited in claim 1, further comprising assigning said second value useable to satisfy said transaction value portion based upon an independently defined exchange rate between said value classification of said second value and said value classification of said cryptocurrency, less a transaction fee.

3. The method as recited in claim 1, wherein a value classification of said transaction value has a defined exchange rate to said value classification of said second value.

4. The method as recited in claim 1, further comprising utilizing an independently defined exchange rate between said value classification of said second value and said value classification of said cryptocurrency, defined based upon a time of transfer of said cryptocurrency into said user account, as a basis for assigning said second value.

5. The method as recited in claim 1, wherein additional cryptocurrency added to said user account is assigned a second value corresponding to a then current value of said second value classification.

6. The method as recited in claim 1, further comprising deducting a transaction fee from said second value.

7. The method as recited in claim 1, further comprising assigning said second value to specific blocks in said blockchain that define said cryptocurrency in said user account, said second value being assigned to said specific blocks even if additional cryptocurrency is added to said user account; and
determining which blocks in said blockchain will be utilized to satisfy said transaction amount.

8. The method as recited in claim 1, wherein said value classification of said second value is represented in an amount of a second cryptocurrency.

9. The method as recited in claim 1, further structured to verify that said second account is an approved account and to deny a financial transaction with a non-approved account.

10. The method as recited in claim 1, wherein said transaction value is represented in a credit transaction at a merchant associated with said second account.

11. The method as recited in claim 1, further comprising transferring said transaction amount of said cryptocurrency from said user account to a central account via said at least one network adaptor prior to transferring said transaction value to said second account.

12. The method as recited in claim 1, wherein said value classifications of said transaction value and said second value are at least one type of fiat currency.

13. The method recited in claim 1, wherein allocating said transaction amount of said cryptocurrency to satisfy said amount of said transaction value further comprises transferring a portion of said cryptocurrency corresponding to said transaction amount to a central account.

14. A system for conducting financial transaction utilizing blockchain transfers, said system comprising:
a first account maintained and defined on a first microprocessor, said first microprocessor structured to receive and store data associated with a series of blocks of a bock chain corresponding to an amount of cryptocurrency;
at least one system microprocessor;
at least one network adapter; and
at least one memory storing computer-executable instructions, wherein said at least one system microprocessor is coupled to said at least one network adapter and is operable to access said at least one memory and execute said computer-readable instructions to:
identify said amount of cryptocurrency transferred to said first account;
assigning a second value, corresponding to a current value of a second value classification different from said cryptocurrency's value classification, to said amount of cryptocurrency in said first account;
identify a financial transaction with a second account initiated from said first account and determining a transaction value of said financial transaction;
define a transaction amount of said cryptocurrency in said first account required to satisfy said transaction value as a proportion of said second value assigned to said amount of cryptocurrency compared to said transaction value, independent of a then current value of said cryptocurrency in said second value classification;
allocate said transaction amount of said cryptocurrency to satisfy said amount of said transaction value;
transfer said transaction value into said second account.

15. The system as recited in claim 14, wherein said financial transaction comprises a transaction with a liquidity account.

16. The system as recited in claim 14, wherein said computer-readable instructions are further operable to reject a proposed financial transaction at least if said second account is not an authorized account.

17. The system as recited in claim 14, wherein said first microprocessor and said system microprocessor are the same microprocessor.

18. The system as recited in claim 14 wherein said first microprocessor comprises a cryptocurrency storage device.

19. The system as recited in claim 14, wherein said computer-readable instructions are further operable to assign a different amount of said second value, corresponding to a then current value of said second value classification to additional amounts of cryptocurrency transferred to said first account, and to maintain said second values assigned to corresponding portions of said cryptocurrency.

20. The system as recited in claim 14, wherein said computer-readable instructions are further operable to deduct a transaction fee.

21. The system as recited in claim 14, wherein said second value classification is a fiat currency.

22. The system as recited in claim 14, wherein said computer-readable instructions are further operable to apply at least a portion of said transaction value to a retail invoice.

23. The system as recited in claim 14, further comprising a hedging mechanism operable to mitigate volatility of said cryptocurrency amount received into said first account.

24. The system as recited in claim 23, wherein said hedging mechanism is operable to sell held cryptocurrency from a liquidity account and assess a nominal exchange value of said held cryptocurrency prior to said financial transaction so as to mitigate against a decrease in a then current value of the second value classification exchanged with said cryptocurrency's value classification.
